(19) United States
(12) Patent Application Publication
(10) Pub. No.: US 2015/0338601 A1
(43) Pub. Date: Nov. 26, 2015

(54) SPECIAL-SHAPE TUBE LAYING OPTICAL FIBER BUNDLES IN COMMUNICATION ROOM

(71) Applicant: Shijiazhuang Qiushi Communication Equipment Co., Ltd, Shijiazhuang (CN)

(72) Inventors: Qingli LI, Shijiazhuang (CN); Baoyi Dong, Shijiazhuang (CN)

(21) Appl. No.: 14/689,667

(22) Filed: Apr. 17, 2015

(30) Foreign Application Priority Data
May 21, 2014 (CN) 201420261758.6

(51) Int. Cl. G02B 6/44; F16L 9/19

(52) U.S. Cl. CPC G02B 6/4459; F16L 9/19

(57) ABSTRACT

A special-shape tube having an outer sleeve and multiple microtubes is used for the layout of optical fiber bundles in communication room. Microtubes are placed inside the outer sleeve, the section of which is an arbitrary polygon with more than three sides. For the tube, the section of its outer sleeve is a polygon so it can contact the wall closely and improve utilization ratio of indoor space. This is simple and convenient, can be connected reliably without displacement or falling off, achieves good coaxiality, and protects the optical fiber bundles inside. The tube can be laid by multiple construction methods, such as air blowing and water dressing, with quick construction speed, high efficiency and other advantages. Alternatively the tube can be laid independently or by expanding existing communication lines or branch tubes to achieve multiple cables in one tube and sufficient utilization of existing communication line resources.

### BACKGROUND OF THE INVENTION

1. Field of the Invention

This invention relates to a special-shape tube laying optical fiber bundles in communication room; it belongs to the communication equipment technology field.

2. Brief Discussion of the Related Art

As the Code for Design of Communication Engineering for Fiber to the Home in Residential Districts and Residential Buildings and the Code for Construction and Acceptance of Communication Engineering for Fiber to the Home in Residential Districts and Residential Buildings takes effect, the “optical fiber to house” has become the standard configuration for new building, and the optical fiber network construction solves the demands of new and old cities throughout China for interne surfing. For this purpose, all cities throughout China enhances the construction of optical fibers to household.

In the indoor context, optical cables are laid via vertical shaft, concealed tube, open indoor tube, cable tray, or indoor layout. In the traditional conditions, the tube is the round-shape plastic tube, which causes certain difficulty for fixation of tubes and occupies indoor space hugely. In the populated regions, the traditional round plastic tubes can not meet the fire control requirements since they are not halogen-free, flame retardant or innocuous. The traditional layout pattern of indoor optical fibers can not adapt to the construction requirements of new building, and the improvement works of optical fibers in old buildings make the challenge against the traditional layout pattern of optical fibers.

### SUMMARY OF THE INVENTION

The purpose of the utility model is to put forward a special-shape tube used for the layout of optical fiber bundles in communication room, or used for the layout of optical fiber bundles in communication room.

The special-shape tube laying optical fiber bundles in communication room according to the utility model, which is characterized in that: the special-shape tube is composed of outer sleeve and multiple microtubes; the said microtubes are placed inside the outer sleeve; the section of the said outer sleeve is the arbitrary polygon with more than three sides.

The special-shape tube laying optical fiber bundles in communication room according to the utility model has the advantages that:

1. The said special-shape tube laying optical fiber bundles in communication room according to the utility model uses the flame retardant material for its outer sleeve, which makes the special-shape tube free of halide and low smoke, reduces the generation of toxic and hazardous gases when building is on fire, featuring in not only the good environmental protection, but also the huge reduction to the damage of toxic and hazardous gas to humans.

2. The said special-shape tube laying optical fiber bundles in communication room according to the utility model adopts the polygon for the section shape of its outer sleeve, which makes the special-shape tube contact wall closely when being laid, and thence guarantees a simple and convenient construction, a reliable connection without displacement and falling off, and a good coaxiality, even protects the optical fiber bundles inside safely.

3. The said special-shape tube laying optical fiber bundles in communication room according to the utility model can be laid by multiple construction methods, such as air blowing, water dressing, featuring in quick construction speed, high efficiency and other advantages. Alternatively the said special-shape tube can be laid independently or by expanding existing communication line or branch tube to achieve multiple cables in one tube and sufficient utilization on existing communication line resources.

4. The said special-shape tube laying optical fiber bundles in communication room according to the utility model reduces the investment on communication equipment and is beneficial for the stage construction of engineering. When constructing optical fibers in residential districts and buildings, multiple special-shape tubes can be firstly placed inside the weak current well, floor and indoor of house, and then blow optical fibers in microtubes gradually according to the demands of household on communication services. Just like this way, the demands on the laying of optical fibers can not only be met well, but also the initial investment can be saved hugely.

### BRIEF DESCRIPTION OF THE DRAWINGS

FIG. 1 is a schematic diagram for structure of the special-shape tube laying optical fiber bundles.

FIG. 2 is a profile drawing of the special-shape tube.

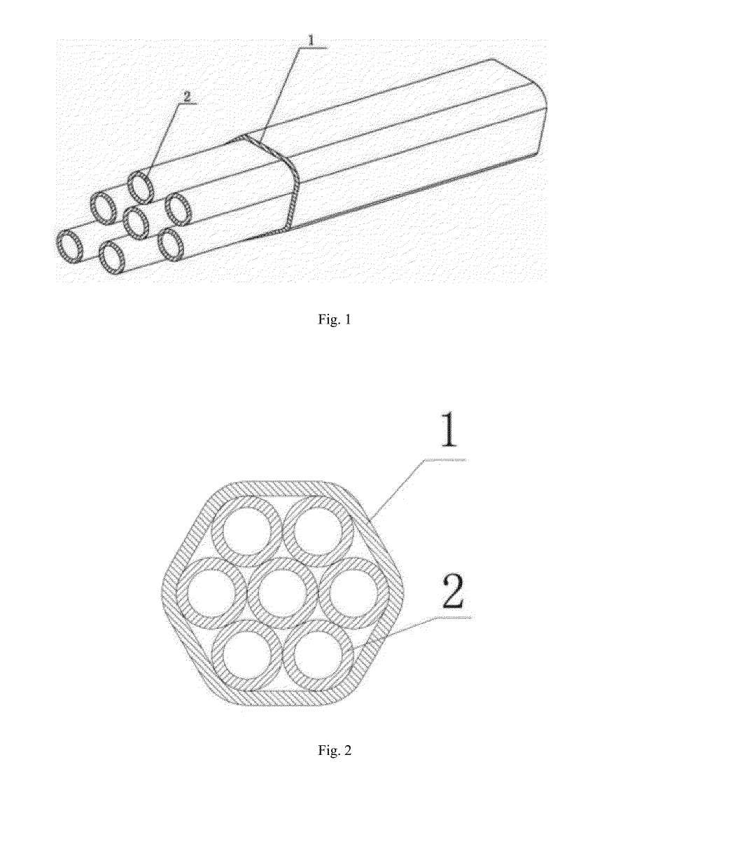

In FIGS. 1 and 2, 1 is outer sleeve, 2 is microtubes.

### DETAILED DESCRIPTION OF THE PREFERRED EMBODIMENTS

The said special-shape tube laying optical fiber bundles in communication room according to the utility model has a structure shown by FIG. 1 as follows, and is composed of outer sleeve 1 and multiple microtubes 2; the said multiple microtubes 2 are placed in the said outer sleeve 1; the cross-section of the said outer sleeve 1 is the arbitrary polygon more than 3 sides, the section of the said outer sleeve is a hexagon (shown by FIG. 2).

For the said special-shape tube laying optical fiber bundles in communication room according to the utility model, the number of its microtubes can be designed according to the actual needs, and it can be 2, 4, 6 or 8 pieces etc. (varying from 2 to 24 pieces), or even more. The thickness of the said outer sleeve can be adjusted according to the quantity of optical fibers. The said special-shape tube can contact wall closely when being laid, so it can improve the utilization ratio of space hugely. The said special-shape tubes can be connected by the microtube contactor; their operation is easy, convenient, reliable, and they can be connected reliably without displacement or falling off to achieve good coaxiality and good protection for the optical fiber bundles inside.

In one embodiment of the utility model, the outer sleeve is a hexagon, and the number of the microtube is 7; the internal and external diameter of microtube is 3.5/5 mm; the indoor optical fiber bundles with 2-12 cores and the external diameter of 1.6 mm can be laid via the air blowing method; the outer sleeve and the microtubes are made from the low-smoke, halogen-free and flame-retardant materials.

1. A special-shape tube laying optical fiber bundles in communication room, wherein the special-shape tube is composed of outer sleeve and multiple microtubes, the said microtubes are placed inside the outer sleeve, and the section of the said outer sleeve is the arbitrary polygon with more than three sides.
